(19) United States
(12) Patent Application Publication
(10) Pub. No.: US 2015/0197986 A1
(43) Pub. Date: Jul. 16, 2015

(54) MULTI-PURPOSE LADDER WITH THREE-PIPE RUNGS

(71) Applicant: KANG-SHUO YEH, Keelung City (TW)

(72) Inventor: KANG-SHUO YEH, Keelung City (TW)

(21) Appl. No.: 14/278,904

(22) Filed: May 15, 2014

(30) Foreign Application Priority Data
Jan. 16, 2014 (TW) 103200945

(51) Int. Cl. E06C 1/16; E06C 1/08

(52) U.S. Cl. CPC E06C 1/16; E06C 1/08

(57) ABSTRACT

A multi-purpose ladder is characterized by that each of the inner rungs is a three-pipe rung composed of an upper tubular rung member, a lower tubular rung member, and an intermediate tubular rung member, wherein the intermediate tubular rung member is a square pipe with two ends thereof joined to the respective pair of inner rails; the upper tubular rung member and the lower tubular rung member each has a triangle-like cross-section and a length equivalent to the span between the respective pair of inner rails with a side along the vertex of the triangle-like cross-section joined to upper and lower sides of the intermediate tubular rung member respectively and a side along the base of the triangle-like cross-section constituting an inner upper pedal side and an inner lower pedal side which oppositely incline an angle corresponding to the outer upper pedal side and the outer lower pedal side, respectively.

### CROSS-REFERENCE TO RELATED APPLICATIONS

The application claims priority from Taiwan Patent Application No. 103200945 filed on Jan. 16. 2014, the disclosure of which is incorporated herein by reference.

### FIELD OF THE INVENTION

The present invention relates to a multi-purpose ladder with three-pipe rungs, and particularly to a multi-purpose ladder in which each of the rungs attached to the inner rails thereof composed of an upper tubular rung member, a lower tubular rung member, and an intermediate tubular rung member.

### BACKGROUND OF THE INVENTION

The rungs on the traditional aluminum ladder are normally fabricated with square pipes jointed to the rails of the ladder; due to the narrow pedal side of the respective rung, it is unable for the user to stamp on steadily such that falling caused by carelessness or instability may happen easily and insecurely. FIG. 4 shows the conventional extendable articulated ladder in a state of “A”-shaped ladder or trestle, wherein the rungs (11′) joined to the inner rail pairs (1′) have a butterfly-shaped cross-section respectively; although the butterfly-shaped rungs each offer larger pedal sides than those of the traditional rungs, there are no supports at one of the edges thereof disadvantageously such that the strength thereof is weak and it is damaged easily.

### SUMMARY OF THE INVENTION

An object of the present invention is to provide a multi-purpose ladder with which each rung associated with inner rails provides a special shaped three-pipe cross-section to overcome deficiencies of the prior art and enhance safety of the user.

In order to achieve the preceding object, the multi-purpose ladder according to the present invention comprises two pairs of inner rails, two pairs of outer rails, a plurality of inner rungs attached to the inner rails, a plurality of outer rungs attached to the outer rails to be characterized by that each of the inner rungs is a three-pipe rung composed of an upper tubular rung member, a lower tubular rung member, and an intermediate tubular rung member, wherein the intermediate tubular rung member is a square pipe with two ends thereof joined to the respective pair of inner rails; the upper tubular rung member and the lower tubular rung member each has a triangle-like cross-section and a length equivalent to the span between the respective pair of inner rails with a side along the vertex of the triangle-like cross-section joined to upper and lower sides of the intermediate tubular rung member respectively and a side along the base of the triangle-like cross-section constituting an inner upper pedal side and an inner lower pedal side which oppositely incline an angle corresponding to the outer upper pedal side and the outer lower pedal side, respectively; hence, structural arrangement of each of the inner rungs with the upper tubular rung member, the lower tubular rung member and the intermediate tubular rung member makes the inner rungs be stamped on safely and conveniently.

### BRIEF DESCRIPTION OF THE DRAWINGS

The present invention can be more fully understood by reference to the following description and accompanying drawings, in which:

FIG. 1 is a perspective view of a multi-purpose ladder with three-pipe rungs according to the present invention in a state of trestle;

FIG. 2 is a partly sectional view of the multi-purpose ladder with three-pipe rungs shown in FIG. 1 illustrating the cross-section of the respective rung thereof;

FIG. 3 is a partly sectional view of the multi-purpose ladder with three-pipe rungs similar to in FIG. 2 illustrating the ladder in a state of single ladder;

FIG. 4 is a partly sectional view of the conventional extendable articulated ladder in a state of trestle illustrating the cross-section of the respective rung thereof.

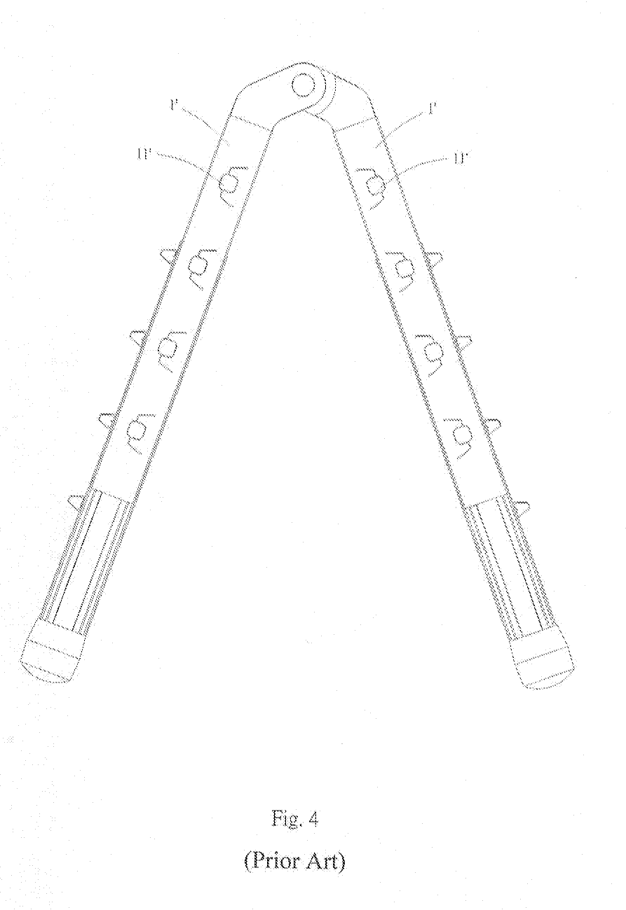

### DETAILED DESCRIPTION OF THE INVENTION

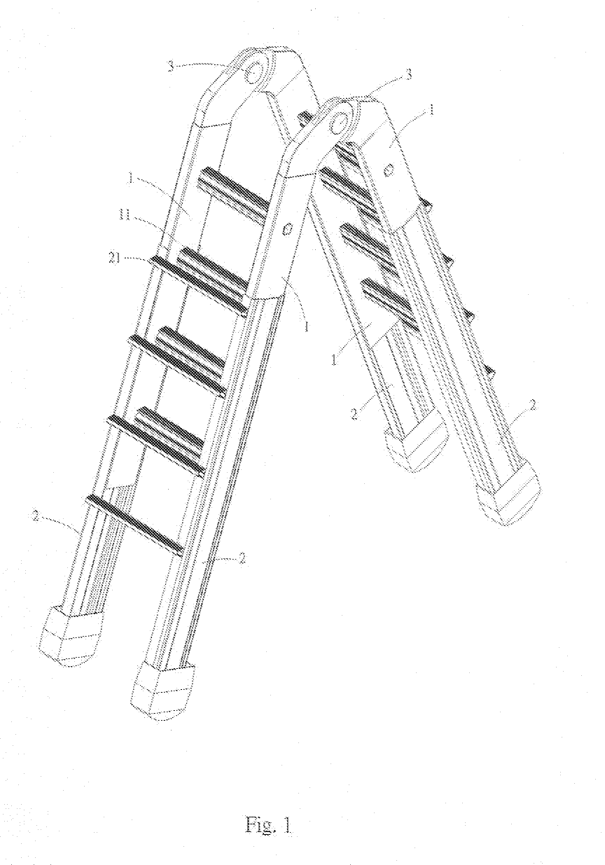

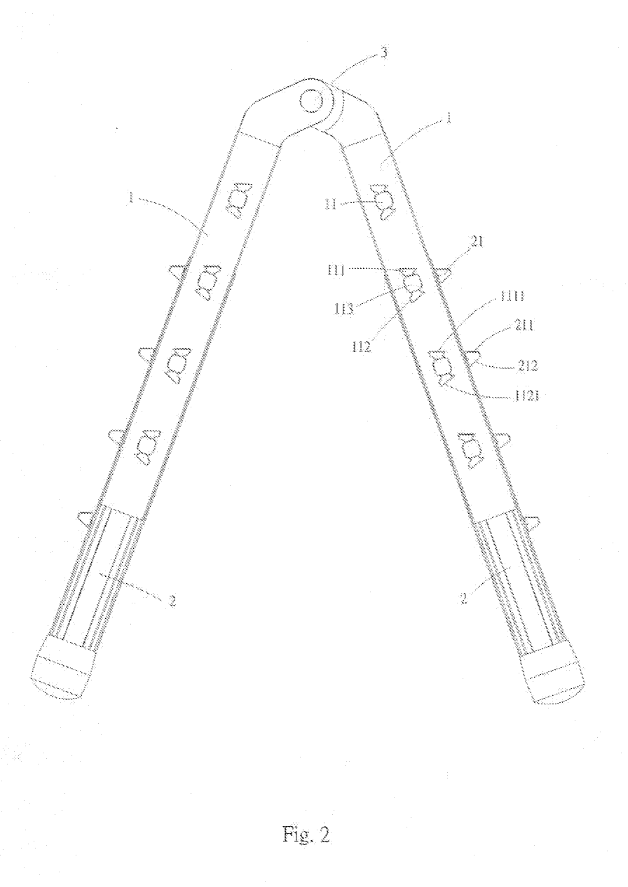

Referring to FIGS. 1 and 2, a multi-purpose ladder with three-pipe rungs according to the present invention basically comprises two pairs of inner rails (1, 1), two pairs of outer rails (2, 2), and two pairs of articulated joints (3, 3); the ladder can be adjusted to become a state of trestle or single ladder. FIGS. 1 and 2 show the ladder has been adjusted in a state of trestle. A plurality of outer rungs 21 attached to the outer rails (2, 2) each have a trapezoid-shaped cross-section; each of the outer rungs (21) provides two opposite outer slant pedal sides, an outer upper pedal side (211), and an outer lower pedal side (212). The outer rails (2, 2) and the outer rungs 21 are conventional and no details will be described further. A plurality of inner rungs 11 are attached to the inner rails (1, 1), and each of the inner rungs 11 is a three-pipe rung composed of an upper tubular rung member (111), a lower tubular rung member (112), and an intermediate tubular rung member (113). The intermediate tubular rung member (113) is a square pipe with two ends thereof joined to the respective pair of inner rails (1, 1); the upper tubular rung member (111) and the lower tubular rung member (112) each has a triangle-like cross-section and a length equivalent to the span between the respective pair of inner rails (1, 1) with a side along the vertex of the triangle-like cross-section joined to the upper and lower sides of the intermediate tubular rung member (113) respectively and a side along the base of the triangle-like cross-section constituting an inner upper pedal side (1111) and an inner lower pedal side (1121) which oppositely incline an angle corresponding to the outer upper pedal side (211) and the outer lower pedal side (212), respectively; thus, the inner upper pedal side (1111) and the outer upper pedal side (211) are disposed on an imaginary inclining plane for being stamped on by the user.

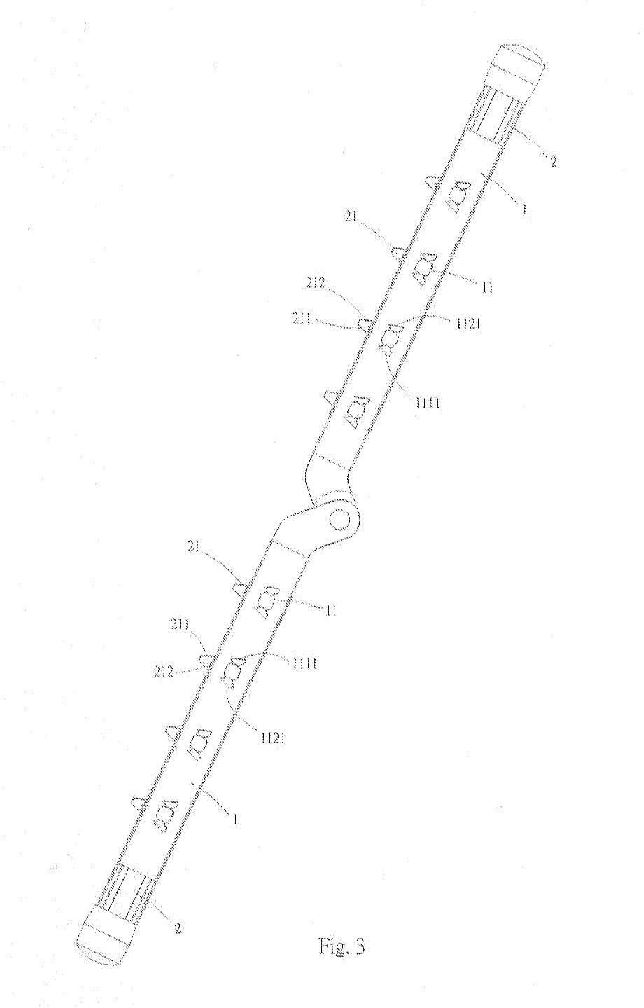

Referring to FIG. 3, at the time of the right ladder part of the multi-purpose ladder shown in FIG. 2 is rotated upward to become a state of single ladder shown in FIG. 3, the inner lower pedal side (1121) becomes above the inner upper pedal side (1111) and is disposed on another imaginary inclining plane with the outer lower pedal side (212) for being stamped on by the user as well.

It is appreciated that the multi-purpose ladder according to the present invention is characterized by that each of the inner rungs attached to the pairs of inner rails (1, 1) is a three-pipe rung integrated with the upper tubular rung member (111), the lower tubular rung member (112), and the intermediate tubular rung member (113), and the upper tubular rung member (111) and the lower tubular rung member (112) have a triangle-like cross-section respectively such that the configuration and structural arrangement of the respective inner rung are not only novel but also stronger and less damaged than the conventional rungs to secure safety while in use.

While the invention has been described with reference to the preferred embodiment thereof, it is to be understood that modifications or variations may be easily made without departing from the spirit of this invention defined by the appended claims.

What is claimed is:

1. A multi-purpose ladder with three-pipe rungs comprising:
two pairs of inner rails;
two pairs of outer rails;
a plurality of inner rungs attached to the inner rails;
a plurality Of outer rungs attached to the outer rails, wherein each of the outer rungs has an upper outer inclined pedal side and a lower outer inclined pedal side;
two pairs of articulated joints attached to the two pairs of the inner rails;
characterized by that each of the inner rungs is a three-pipe rung composed of an upper tubular rung member, a lower tubular rung member, and an intermediate tubular rung member, wherein the intermediate tubular rung member is a square pipe with two ends thereof joined to the respective pair of inner rails; the upper tubular rung member and the lower tubular rung member each has a triangle-like cross-section and a length equivalent to a span between the respective pair of inner rails with a side along a vertex of the triangle-like cross-section joined to upper and lower sides of the intermediate tubular rung member respectively and a side along a base of the triangle-like cross-section constituting an inner upper pedal side and an inner lower pedal side which oppositely incline an angle corresponding to the outer upper pedal side and the outer lower pedal side, respectively;
whereby, each of the inner rungs with the upper tubular rung member, the lower tubular rung member and the intermediate tubular rung member makes the inner rungs be capable of being stamped on safely and conveniently.
